(19) United States
(12) Patent Application Publication
(10) Pub. No.: US 2006/0021533 A1
(43) Pub. Date: Feb. 2, 2006

(54) Imprint stamp

(76) Inventor: Albert H. Jeans, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/903,300

(22) Filed: Jul. 30, 2004

(51) Int. Cl. B41K 1/02

(52) U.S. Cl. 101/327

(57) ABSTRACT

An imprint stamp made from a high fluorine content material and a method of fabricating an imprint stamp from a high fluorine content material are disclosed. The imprint stamp includes an imprint pattern that can be formed in the imprint stamp during a molding process wherein the high fluorine content material is applied to a mold that includes a pattern to be replicated in the high fluorine content material to form the imprint pattern. The high fluorine content material of the imprint stamp is resistant to blending, pairing, and swelling. An imprint stamp made from the high fluorine content material can be used for several hundred or more embossing steps without damage or wear to the imprint stamp and/or the imprint pattern.

### FIELD OF THE INVENTION

The present invention relates generally to an imprint stamp and a method for making an imprint stamp. More specifically, the present invention relates to an imprint stamp made from a high fluorine content material and a method of making an imprint stamp from a high fluorine content material.

### BACKGROUND OF THE INVENTION

Imprint lithography (also referred to as soft lithography) is an increasingly popular lithography process for forming features in a media where the feature size is smaller than a wavelength of light used for conventional photolithography processes. An imprint stamp is a structure that includes an imprint pattern formed on the structure. The imprint stamp and a media (e.g. a photopolymer) are urged into contact with each other so that the imprint pattern is transferred to the media. Typically, the media is cured either during the transfer or immediately after the transfer so that the pattern replicated in the media retains its shape and complements the imprint pattern on the imprint stamp. Advantages of imprint lithography over conventional light based photolithography or electron-beam lithography include high throughput processing at a lower cost and an ability to imprint patterns with feature sizes that are of a submicron scale or less. For example, feature sizes that are of a micron scale can be imprinted.

Polydimethyl Siloxane (PDMS), a silicone-base elastomer material, is becoming widely used in nano-imprint lithography for making high-resolution imprint stamps. In particular, a DOW CORNING® silicone-based conformal coating, SYLGARD 184® silicone elastomer, is widely used because of its prevalence in the literature. The many useful characteristics of the aforementioned silicone-base elastomer materials include: they are transparent to ultraviolet light; they have a high gas permeability; they are flexible and conform to non-planar and uneven surfaces; and they are a low cost and widely available material. Moreover, other silicone-based conformal coatings from DOW CORNING® having properties similar to those of SYLGARD 184® have also been widely used for high-resolution imprint stamps used in soft lithography. Those silicone-based conformal coatings include but are not limited to SYLGARD 182® silicone elastomer, SYLGARD 183® silicone elastomer, and SYLGARD 186® silicone elastomer.

However, there are several disadvantages to prior imprint stamps made from silicone-based elastomer materials such as PDMS. First, in thin sheets, PDMS is very difficult to handle because it is elastic, tears easily, and is tacky and tends to stick to itself. Therefore, careful handling is required in order to prevent damage to an imprint stamp made from PDMS-based silicone-based elastomer materials.

Second, on a micron or smaller scale, PDMS is not a stable material. Small features and sharp edges formed in a layer of PDMS tend to “blend” over a period of weeks. As a result, small features formed in the PDMS are obliterated and are not resolved with high fidelity. Therefore, features in a mold that are transferred to the imprint stamp are not faithfully reproduced in the imprint pattern.

Third, although PDMS has a low surface energy that gives it good release characteristics with respect to other materials, PDMS is itself tacky as molded and is prone to a phenomena known as “pairing” where adjacent features formed in a layer of PDMS tend to stick to each other. As a result, the imprint pattern formed in a PDMS-based silicone-based elastomer material becomes distorted and does not retain the shape of the pattern replicated in it during the molding and curing processes.

Fourth, the high gas permeability of PDMS can result in swelling caused by an uptake of various compounds present in the environment where the PDMS is molded. Specifically, solvents used in the soft lithography process can swell silicon elastomers based on PDMS, such as the aforementioned SYLGARD 184®. Consequently, those compounds are absorbed and retained by the PDMS and distort or destroy the features in the imprint stamp. The aforementioned third and fourth disadvantages become readily apparent when a PDMS-based imprint stamp is used hundreds of times in an imprinting or embossing process where the imprint stamp is urged into contact with a media to be imprinted, as would occur in a manufacturing environment.

In FIG. 1a, a photopolymer material was molded with a prior PDMS-based imprint stamp when the imprint stamp was new (i.e. the first printing using the stamp). Accordingly, FIG. 1a depicts the imprint pattern as replicated in the photopolymer material. The replicated pattern is well defined and is substantially devoid of defects. In sharp contrast, in FIG. 1b, a photopolymer material was molded with the same PDMS imprint stamp after the stamp had been used for about 200 embossing steps. The photopolymer material includes distorted and obliterated features that were replicated in the photopolymer material by the imprint stamp. Those replicated features depict the defects and damage to the imprint pattern after about 200 pressing with the same imprint stamp. Due to changes in feature geometry and surface properties of the PDMS imprint pattern on the stamp, parts of the PDMS imprint pattern were ripped out during the embossing process, leaving voids in the imprint pattern which were filled in by the photopolymer material when the imprint pattern and the photopolymer material were urged into contact with each other. The changes in feature geometry and surface properties of the PDMS are due in large part to the swelling of the PDMS as described above.

In FIG. 2a, a prior imprint stamp 401 made from a PDMS-based material includes an imprint pattern 403 formed in the stamp 401. The PDMS material can be SYLGARD 184®, for example. In FIG. 2b, the imprint pattern 403 is coated to a thickness of about a few tens of nanometers with an amorphous fluoropolymer coating 405 that conformally covers a surface of the imprint pattern 403. However, the imprint patterns 403 themselves are made from the PDMS-based material. The amorphous fluoropolymer can be a Teflon® AF material such as the type manufactured by DUPONT®. The Teflon® AF material can be deposited on the imprint pattern 403 using a spin-coating process.

Reference in now made to FIG. 2c, wherein a substrate 411 includes an imprint media 407 (e.g. a photopolymer). The imprint stamp 401 and the imprint media 407 are urged U into contact with each other to replicate the imprint the pattern 403 in the imprint media 407 as depicted in FIG. 2d. The imprint media 407 can be irradiated with a UV light source to cure the imprint media 407. In FIG. 2e, the imprint media 407 includes a replicated pattern 409 that compliments the imprint pattern 403.

The very thin amorphous fluoropolymer coating 405 on the imprint pattern 403 prevents the aforementioned problems associated with swelling and deformation in prior imprint stamps made solely from PDMS. Furthermore, the coating 405 provides for a uniform imprint pattern transfer over a large area of the imprint media 407. However, one disadvantage to the very thin amorphous fluoropolymer coating 405 (e.g. a Teflon® AF coating) on the imprint pattern 403 is that there is no indication that the imprint stamp 401 can be used more than once without having to re-coat the imprint pattern 403 because the amorphous fluoropolymer coating 405 has worn off. Moreover, a second disadvantage is that there is no indication that in a mass production soft lithography process where several hundred or more embossing by the same imprint stamp 401 are required, that imprint patterns 403 will not be damaged or worn out long before the required number of embossing have occurred or that the very thin amorphous fluoropolymer coating 405 will not have worn off of the imprint patterns 403 long before the required number of embossing have occurred, thus leading to the aforementioned problems caused by swelling and deformation.

Consequently, there is a need for an imprint stamp that is made from a material that is mechanically stable and resilient so that the imprint stamp can endure several hundred or more embossing steps without an imprint pattern carried by the stamp becoming damaged or distorted. There is also a need for an imprint stamp that is made from a material that resists blending, pairing, and swelling so that the imprint pattern retains a high fidelity over several hundred embossing steps. Finally, there exists a need for an imprint stamp that is made from a material that is flexible to facilitate easy mold release and conformal contact with other surfaces.

### SUMMARY OF THE INVENTION

Broadly, the present invention is embodied in an imprint stamp made from a high fluorine content material and a method of fabricating an imprint stamp from a high fluorine content material.

The imprint stamp includes an imprint pattern and both the imprint stamp and imprint pattern are made from a high fluorine content material. A method of fabricating an imprint stamp includes applying a high fluorine content material to a stamp master that includes a pattern to be replicated as an imprint pattern in the imprint stamp. The high fluorine content material is then cured to fix the imprint pattern in the imprint stamp. After the curing, the imprint stamp is removed from the stamp master. The high fluorine content material can include but is not limited to a fluoropolymer, an amorphous fluoropolymer, and a perfluoropolyether.

The high fluorine content material is non-tacky, has a low coefficient of friction, mechanically stable, mechanically resilient, thermally stable, and chemically inert so that the imprint pattern carried by the imprint stamp can endure several hundred or more embossing without significant degradation (e.g. damage, tearing, wear, or distortion) of the imprint pattern. The high fluorine content material resists blending, swelling, and pairing so that the imprint pattern formed in the imprint stamp retains a high fidelity over several hundred or more embossings. The high fluorine content material of the imprint stamp is flexible so that the imprint stamp can be conformally connected with a substrate. The flexibility and non-tackiness of the high fluorine content material facilitate easy mold release from the stamp master so that the imprint stamp and/or the imprint pattern are not damaged by the mold release process.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1a is a SEM image depicting a photopolymer material molded by a prior PDMS-based imprint stamp when the imprint stamp was new.

FIG. 1b is a SEM image depicting a photopolymer material molded by the same prior PDMS-based imprint stamp of FIG. 1a after about 200 embossing steps.

FIG. 2a is a cross-sectional view depicting a prior imprint stamp made from a PDMS-based material.

FIG. 2b is a cross-sectional view depicting a very thin amorphous fluoropolymer coating on a surface of an imprint pattern of the prior imprint stamp of FIG. 2a.

FIGS. 2c through 2e are cross-sectional views depicting an embossing of an imprint media using the prior imprint stamp of FIG. 2b.

FIG. 3a is a cross-sectional view depicting an imprint stamp made from a high fluorine content material.

FIGS. 3b and 3c are cross-sectional views depicting an imprint stamp made from a high fluorine content material and connected with a substrate.

FIGS. 4a and 4b are cross-sectional views depicting an imprint stamp made from a high fluorine content material and connected with cylindrical and arcuate substrates respectively.

FIG. 5 is a flow diagram depicting a method of fabricating an imprint stamp from a high fluorine content material.

FIG. 6a is a cross-sectional view depicting a stamp master.

FIG. 6b is a cross-sectional view depicting an applying of a high fluorine content material and a curing of the high fluorine content material.

FIG. 6c is a cross-sectional view depicting a removing of an imprint stamp from a stamp master.

FIG. 6d is a cross-sectional view depicting an imprint stamp fabricated from a high fluorine content material.

FIGS. 7a and 7b are cross-sectional views depicting a connecting of an imprint stamp made from a high fluorine content material with a substrate.

FIG. 8a is a SEM image depicting a photopolymer material embossed by an imprint stamp made from a high fluorine content material when the imprint stamp is new.

FIG. 8b is a SEM image depicting a photopolymer material embossed by the same imprint stamp used for the embossing in FIG. 8a after about 500 embossing steps by the imprint stamp.

FIG. 8c is a SEM image depicting a high fidelity of complex features embossed in a photopolymer material by an imprint stamp made from a high fluorine content material.

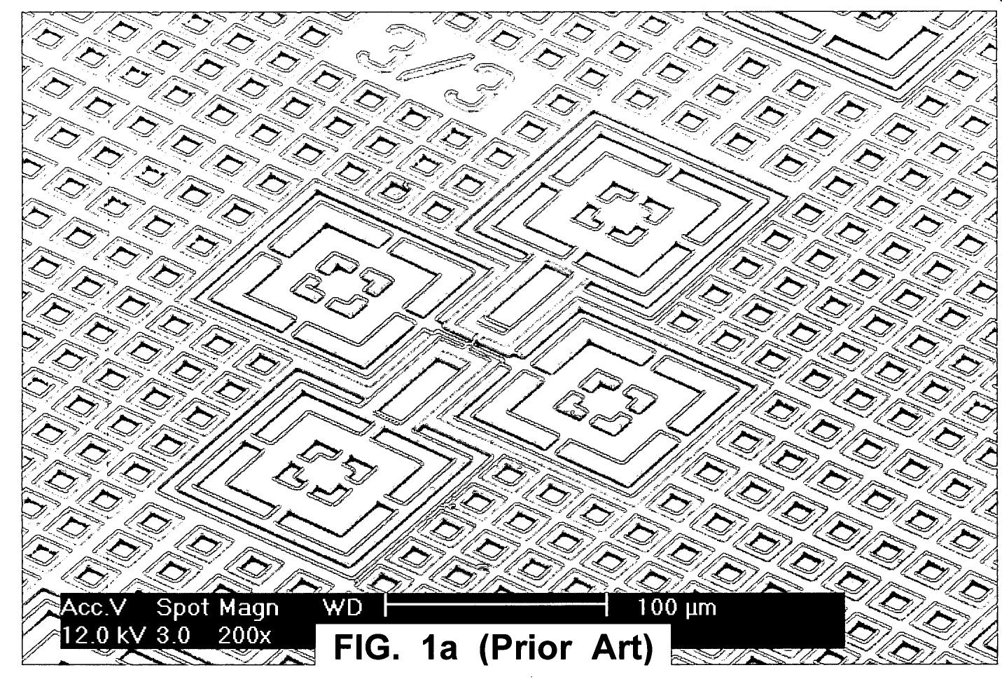

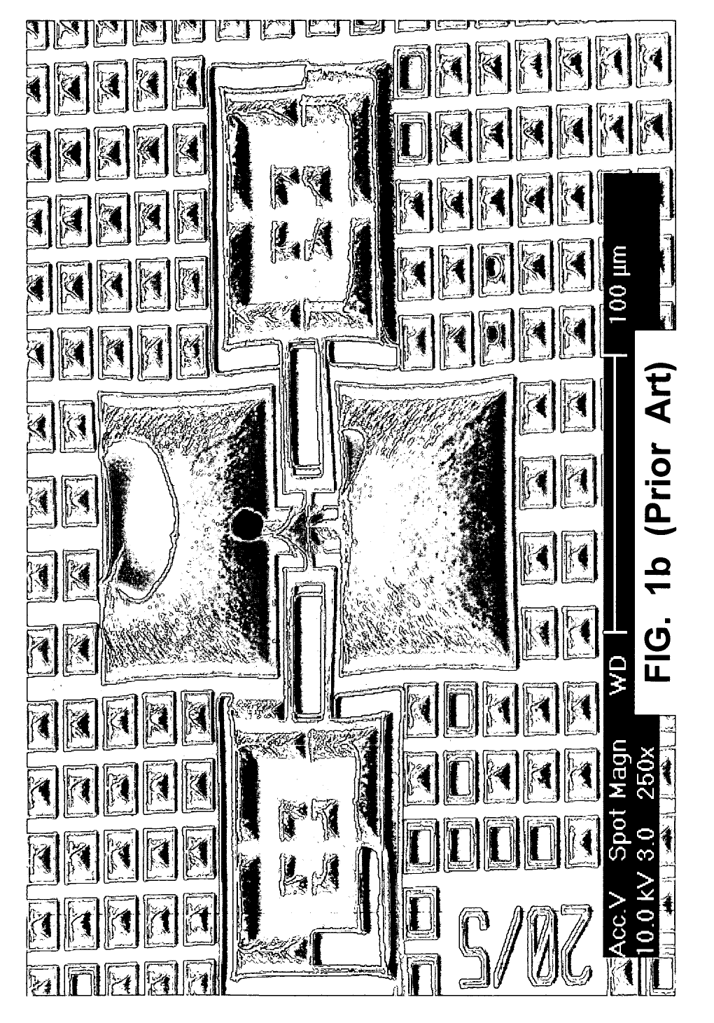

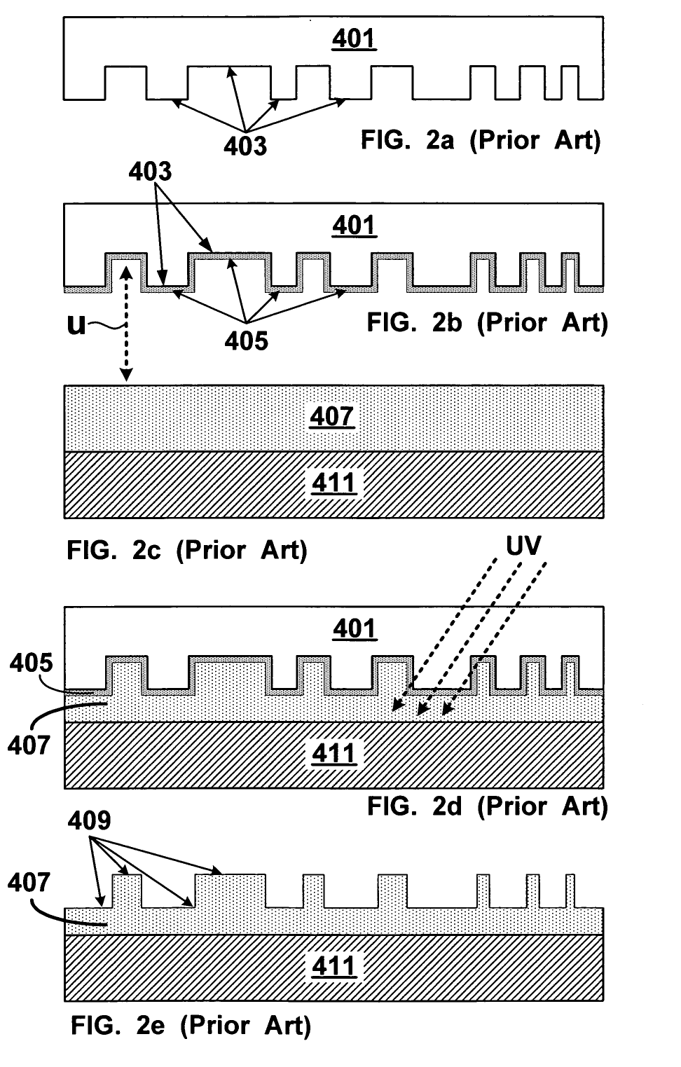

### DETAILED DESCRIPTION

in the following detailed description and in the several figures of the drawings, like elements are identified with like reference numerals.

As shown in the drawings for purpose of illustration, the present invention is embodied in an imprint stamp made from a high fluorine content material and a method of fabricating an imprint stamp from a high fluorine content material. Both the imprint stamp and the imprint pattern are made from the high fluorine content material. An imprint pattern of high fidelity can be formed in the high fluorine content material of the imprint stamp because the high fluorine content material resists blending, pairing, and swelling that can result in entrainment of contaminants and a loss of imprint pattern accuracy. The imprint stamp can be used in a manufacturing process (e.g. a soft lithography process) to emboss a media several hundred or more times without damage or wear to the imprint pattern. Consequently, a high fidelity and substantially defect free pattern can be replicated in the media by the imprint stamp.

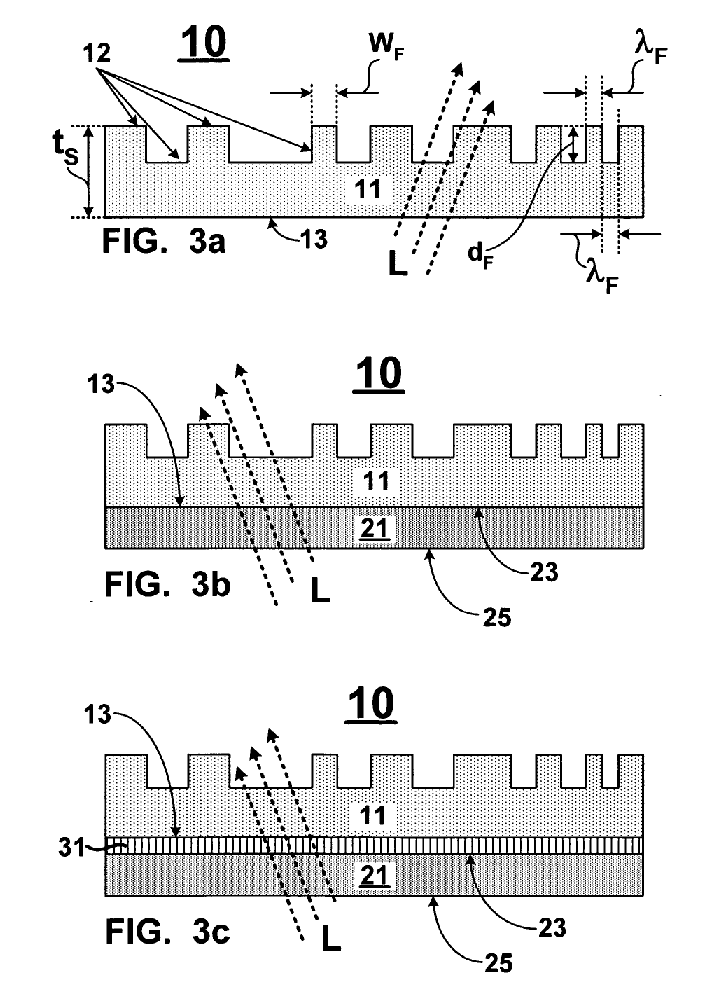

Turning to FIG. 3a, an imprint stamp 10 includes an imprint pattern 12 connected with the imprint stamp 10. The imprint pattern 12 and the imprint stamp 10 are made from a high fluorine content material 11. The high fluorine content material 11 can be a material including but not limited to a fluoropolymer (also referred to as a perfluoropolymer), an amorphous fluoropolymer, and a perfluoropolyether (PFPE). Typically, the imprint stamp 10 and the imprint pattern 12 are integrally formed (i.e are a unitary whole) as part of a molding process where the high fluorine content material 11 is cast in a mold that includes a pattern to be replicated in the imprint stamp 10 to form the imprint pattern 12. The imprint stamp 10 can be very thin and can have a thickness t_{S} of a few millimeters or less. Typically, the thickness t_{S} can be less than 1.0 mm. For example, the thickness t_{S} can be 0.3 mm.

The actual features and shapes that comprise the imprint pattern 12 will be application specific and can include any pattern that can be formed in the high fluorine content material 11. The imprint pattern 12 can include a minimum feature size λ_{F}. The minimum feature size λ_{F} is a size of the smallest feature that can be resolved in the high fluorine content material 11. As one example, in FIG. 3a, the minimum feature size λ_{F} can be a minimum width of one of the features that comprises the imprint pattern 12 and/or a minimum space between adjacent features in the imprint pattern 12. One advantage of the high fluorine content material 11 is that a complex high resolution pattern with submicron sized features can be formed in the high fluorine content material 11. For example, the minimum feature size λ_{F} in the imprint pattern 12 can be less than 100 nm.

An additional advantage to using the high fluorine content material 11 to form the imprint stamp 10 is that a depth d_{F} of the features can be large relative to a width W_{F} of the features in the imprint pattern 12. Accordingly, an aspect ratio (d_{F}÷W_{F}) can be large (i.e. d_{F}>>W_{F}) without pairing between adjacent features in the imprint pattern 12. A large aspect ratio is particularly desirable when the depth d_{F} is much larger than the minimum feature size λ_{F} (i.e. d_{F}>>λ_{F}) because adjacent features in the imprint pattern 12 stand proud of the imprint stamp 10 without pairing (i.e. without sticking to one another) or leaning towards one another.

Desirable properties for the high fluorine content material 11 include an atomic structure comprising carbon (C) and fluorine (F) atoms that are chemically bonded to each other by covalent bonds. An exemplary structure comprises a backbone of carbon-carbon bonds and carbon-fluorine bonds that form extremely strong covalent bonds between the carbon-carbon bonds and the carbon-fluorine bonds. Moreover, the carbon-fluorine bonds form a sheath around the carbon-carbon bonds that give the high fluorine content material 11 a high resistance to chemical attack (i.e. it is chemically inert) and a low coefficient of friction. PTFE is one example of such a structure. The structure may also include oxygen (O) and chlorine (CI) atoms. For example, perfluoropolymers, including commercially available fluoropolymers, can include oxygen (O) and/or chlorine (CI) atoms that form covalent bonds with the carbon (C) atoms. Perfluorinated polymers are preferable to partially fluorinated polymers because the latter includes hydrogen (H) atoms that bond with the carbon (C) atoms. Consequently, partially fluorinated polymers have undesirable properties including increased hardness and reduced thermal stability relative to perfluorinated polymers.

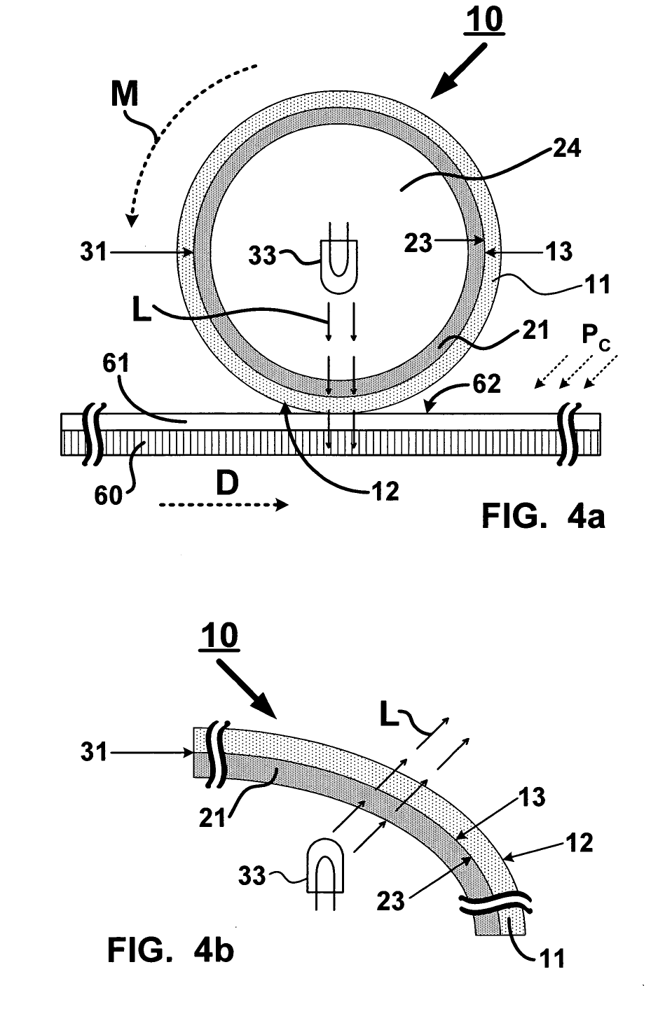

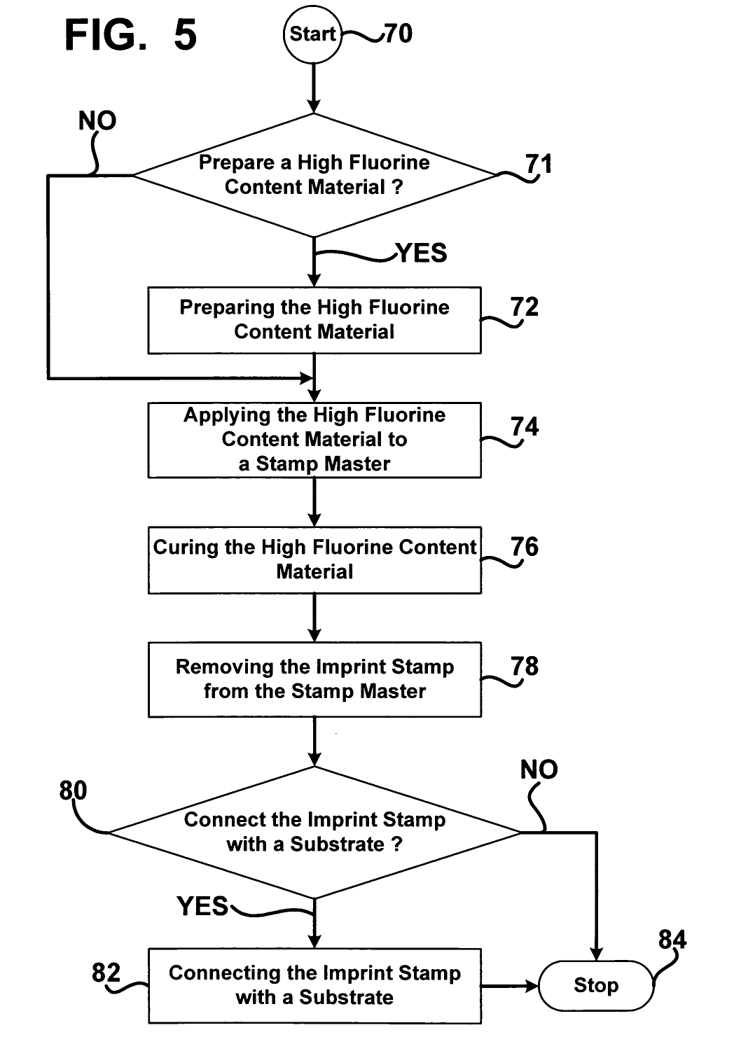

Reference is now made to FIGS. 3b and 3c, wherein the imprint stamp 10 can optionally be connected with a substrate 21. The substrate 21 can be made from a rigid material or a flexible material. The substrate 21 can have a shape including but not limited to a substantially planar shape, a cylindrical shape (see FIG. 4a), and an arcuate shape (see FIG. 4b). The substrate 21 can be used as a handling substrate that allows the imprint stamp 10 to be handled without damaging the imprint stamp 10 and/or the imprint pattern 12. Furthermore, the substrate 21 can be used to mount the imprint stamp 10 to an apparatus that urges the imprint stamp 10 into contact with a workpiece (e.g. a media) to be embossed with the imprint pattern 12.

The imprint stamp 10 can be connected with the substrate 21 by connecting a surface 13 of the imprint stamp 21 with a surface 23 of the substrate 21 as depicted in FIG. 3b. As one example, in FIG. 3c, an adhesive 31 may be applied to the surfaces (13, 23) to connect the substrate 21 and the imprint stamp 10 with each other. The adhesive 31 can be an adhesive film or the adhesive 31 can be coated or otherwise applied to one or both of the surfaces (13, 23). As another example, a glue can be used to connect the imprint stamp 10 with the substrate 21. A suitable material for the adhesive 31 includes but is not limited to an Adhesives Research, Inc.® ARclear® DEV-8932 optically transparent silicone adhesive. For instance, a 25.0 μm thick sheet of an ARclear™ DEV-8932 double-sided adhesive can be used for the adhesive 31.

In some applications it may be desirable for the high fluorine content material 11 to be optically transparent to light. As a first example, the high fluorine content material 11 can be a photocurable material and it may be desirable to cure the high fluorine content material 11 using a light L so that the imprint stamp 10 cures to a solid state (see FIG. 3a). The curing may occur when the imprint stamp 10 is being molded so that the imprint pattern 12 is fixed (i.e. retains its shape and pattern fidelity) in the imprint stamp 10. Therefore, the high fluorine content material 11 can be optically transparent to the light L. Because some photocurable high fluorine content materials 11 can be optically cured using ultraviolet light (UV), the high fluorine content material 11 can be optically transparent to ultraviolet light.

As a second example, after the imprint stamp 10 has been formed, a media to be embossed with the imprint pattern 12 may be a photocurable material, such as a photopolymer, for example. The photocurable material can be cured by the light L passing through the imprint stamp 12 during the embossing step or very soon thereafter. Typically, photocurable materials are cured by ultraviolet light; therefore as described above, the imprint stamp 12 can be optically transparent to ultraviolet light so that the photocurable material is cured by light of an appropriate wavelength.

As a third example, if the imprint stamp 10 is connected with the substrate 21, then for the reasons set forth above, it may be desirable for the substrate 21, the high fluorine content material 11, or both the substrate 21 and the high fluorine content material 11 to be optically transparent to the light L and the light L can be ultraviolet light. It is also preferable for the adhesive 31 to be optically transparent to the light L when the imprint stamp 10 is connected with the substrate 21 using the adhesive 31 (see FIG. 3c). For example, the aforementioned ARclear™ DEV-8932 double-sided adhesive can be used for the adhesive 31 because it is optically transparent to light, including ultraviolet light.

Turning to FIGS. 4a and 4b, the imprint stamp 10 is connected with a cylindrical substrate 21 and an arcuate substrate 21 respectively. In FIG. 4a, a flexible imprint stamp 10 is connected with a cylindrical substrate 21. As described above, an adhesive 31 can be applied to the surfaces (13, 23) to connect the imprint stamp 10 with the substrate 21. A film 60 including a media 61 to be embossed by the imprint stamp 10 is urged into contact with the imprint stamp 10 so that the imprint pattern 12 is replicated in the media 61 as an embossed pattern 62. The film 60 may be stored on a spool and machinery (not shown) can un-spool the film 60 and then coat the film 60 with a uniformly thick layer of the media 61. The substrate 21 can be connected to machinery that rotates the substrate 21 in the direction of a dashed arrow M and the film 60 can be driven in the direction of a dashed arrow D so that the imprint stamp 10 contacts the media 61 and the imprint pattern 12 is embossed in the media 61.

As one example, the media 61 can be a liquid photopolymer material and a Gravure Coater, a Micro Gravure™ Coater, a Slot Die Coater, or the like can be used to coat the film 60 with a uniform thickness of the media 61. The photopolymer material can include but is not limited to a NorIand™ Optical Adhesive that cures when irradiated by ultraviolet light. For example, a Norland® NOA 83H photopolymer can be used for the media 61. The photopolymer material can be mixed with a solvent, such as acetone, for example, to thin the photopolymer material and facilitate coating the film 60 with a very thin layer of the photopolymer material (i.e. the media 61).

The substrate 21 and the imprint stamp 10 can be optically transparent to light L so that a light source 33 positioned in an interior portion 24 of the substrate 21 can irradiate the media 61 with the light L to cure the media 61 during the embossing so that the embossed pattern 62 solidifies and retains its shape. The light source 33 can be an ultraviolet light source for curing the media 61 when the media 61 comprises a photoactive material (e.g. a photopolymer). A post curing P_{C} (e.g. heating, drying, or irradiating) of the media 61 may occur after the embossing of the pattern 62 to further cure the media 61.

In FIG. 4b, a flexible imprint stamp 10 is connected with an arcuate substrate 21. The substrate 21 and the imprint stamp 10 may be optically transparent to the light L so that the light source 33 can irradiate a media (not shown) through the substrate 21 and the imprint stamp 10 during an embossing process. Suitable materials for the substrate 21 include but are not limited to silicon (Si), a semiconductor material, quartz, glass, a borosilicate glass, a metal, a composite material, and a flexible material including a flexible belt. Suitable flexible materials include but are not limited to a Polyester film and a Mylar® film.

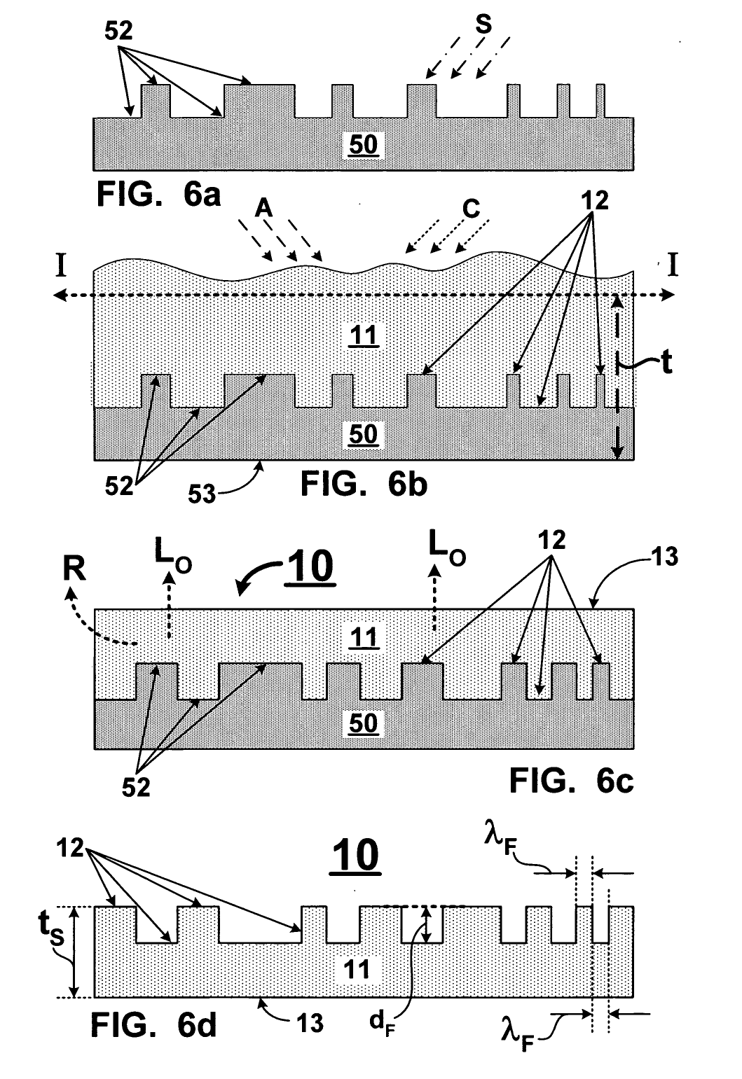

Referring to FIG. 5 and to FIGS. 6a and 6b, a method of fabricating an imprint stamp 10 includes at a stage 74, applying A the high fluorine content material 11 to a stamp master 50. The stamp master 50 serves as a mold in which the imprint stamp 10 and the imprint pattern 12 are formed. As was described above, the high fluorine content material 11 can be a material including but not limited to a fluoropolymer, an amorphous fluoropolymer, and a perfluoropolyether (PFPE). The stamp master 50 includes a pattern 52 to be replicated in the imprint stamp 10 as an imprint pattern 12. As one example, the stamp master 50 can be a material such as silicon (Si) wafer that has been previously fabricated using processes that are well understood in the microelectronics and soft lithography arts. The pattern 52 can be formed in the stamp master 50 using processes including but not limited to photolithography, isotropic etching, and anisotropic etching, just to name a few.

Although, the high fluorine content material 11 typically includes excellent mold release properties, in FIG. 6a the stamp master 50 can optionally be coated S with a very thin layer (e.g. a few nanometers thick) of a release material, such as a mold release material, prior to the applying A at the stage 74. Suitable materials for the mold release material include but are not limited to a fluorocarbon material. As an example, the fluorocarbon material can be deposited using a plasma deposition of a trifluoromethane (CHF₃) gas for a predetermined time (e.g about 5.0 minutes). However, the predetermined time can vary based on the process and materials used to coat S the stamp master 50.

In FIG. 6b, the applying A at the stage 74 can be accomplished using a process including but not limited to coating, pouring, spraying, spin coating, depositing, brushing, dipping, and spreading the high fluorine content material 11 on the stamp master 50. For example, the high fluorine content material 11 can be poured onto the stamp master 50. Preferably, the high fluorine content material 11 has a uniform thickness t across the stamp master 50 as depicted by a dashed line I-I. The uniform thickness t can be achieved by placing shims (not shown) astride the stamp master 50 and then using a Meyer rod (not shown) to uniformly spread the high fluorine content material 11 over the stamp master 50 with the shims setting the thickness t. In FIG. 6b, a bottom surface 53 of the stamp master 50 is selected as the reference point for measuring the thickness t; however, some other reference point can be selected. One advantage to a uniform thickness t is that a surface 13 of the imprint stamp 10 will be substantially planar (i.e. flat) and can be used as surface to mount the imprint stamp 10 to another structure, such as the aforementioned substrate 21, for example. The thickness t will be application dependent; however, a typical thickness for an imprint stamp for use in soft lithography can be only a few millimeters. For instance, the thickness t can be from about 0.2 mm thick to about 0.5 mm thick. As a result, the thickness t_{S} of the imprint stamp 10 can be less than the thickness t (t_{S}<<t).

At a stage 76, the high fluorine content material 11 is cured C so that the imprint stamp 10 obtains a solid state and the imprint pattern 12 is fixed in the imprint stamp 10. Although the imprint stamp 10 reaches a solid state due to the curing C, the imprint stamp 10 may still be flexible. After the curing C, the pattern 52 is replicated with a high fidelity in the imprint pattern 12. The curing C process will depend on the material selected for the high fluorine content material 11. If the material is a photocurable material, then light (e.g. ultra violet light) can be used to cure C the high fluorine content material 11. Drying and heating for a predetermined time may also be used to cure C the high fluorine content material 11. The heating and the drying can occur in an air ambient or in a gas ambient (e.g. nitrogen). The curing C can include but is not limited to heating, drying, irradiating with light, and any combination of heating, drying, and irradiating with light.

In FIG. 6c, at a stage 78, the imprint stamp 10 is removed from the stamp master 50. The removing at the stage 78 can include but is not limited to peeling the imprint stamp 10 off of the stamp master 50, applying an adhesive material to the imprint stamp 10 and then peeling the imprint stamp 10 off of the stamp master 50, applying an adhesive material to the imprint stamp 10 and then lifting the imprint stamp 10 off of the stamp master 50, and applying an adhesive material to the imprint stamp 10 and then rolling the imprint stamp 10 off of the stamp master 50.

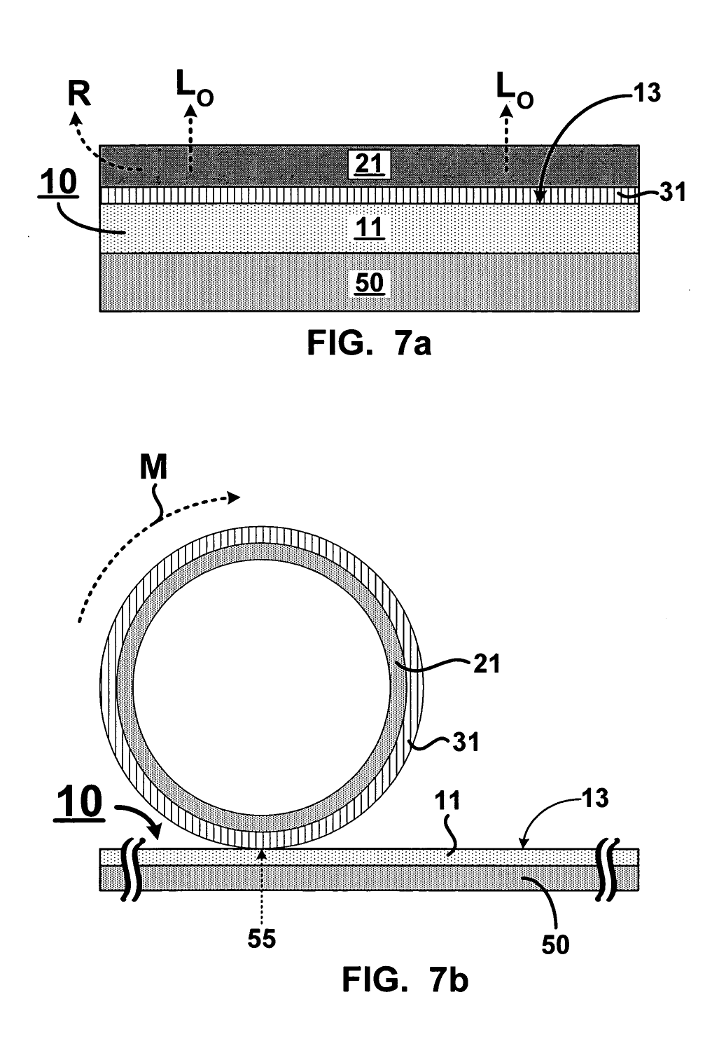

As one example, a tool such as a pair of tweezers, a vacuum wand, or the like can be used to grasp the surface 13 of the imprint stamp 10 and then peel R or lift L_{O} the imprint stamp 10 off of the stamp master 50 as depicted in FIG. 6c. As a second example, in FIG. 7a, an adhesive 31 can be applied to the surface 13 of the imprint stamp 10 and then the imprint stamp 10 can be peeled R or lifted off L_{O} the stamp master 50 by applying a peeling or lifting force to the adhesive 31. Alternatively, the adhesive 31 can be a double-sided adhesive and a substrate 21 or a tool can be connected with the adhesive 31 and a peeling or lifting force can be applied to effectuate the removing of the imprint stamp 10.

Finally, as a third example, in FIG. 7b, a cylindrical substrate 21 can have a double-sided adhesive 31 connected therewith and the adhesive 31 can be positioned in contact with the surface 13 of the imprint stamp 10 (see dashed arrow 55). The cylindrical substrate 21 can then be rolled in the direction of the dashed arrow M to roll the imprint stamp 10 off of the stamp master 50. The imprint stamp 10 can be completely rolled onto the cylindrical substrate 21 to form a cylindrical imprint stamp as was described above in reference to FIG. 4a. The substrate 21 can also be a flexible belt (e.g. a continuous belt like a fan belt) and the double sided adhesive 31 can be applied to the belt and used to remove the imprint stamp 10 from the stamp master 50. As was also describe above, a release material may be applied to the stamp master 50 to facilitate the removing at the stage 78. Optionally, at a stage 82, if the imprint stamp 10 has not already been connected with the substrate 21 as part of the removing at the stage 78 (see FIG. 6d), then the imprint stamp 10 can be connected with the substrate 21 as was described above.

In FIG. 5, prior to the applying A of the high fluorine content material 11 at the stage 74, it may be desirable to prepare the high fluorine content material 11. The high fluorine content material 11 may be supplied in a liquid form or a powder form. There may be several reasons for why the high fluorine content material 11 needs to be prepared prior to the stage 74. First, the high fluorine content material 11 may comprise two or more components that need to be combined, blended, or mixed to form the high fluorine content material 11. Second, the high fluorine content material 11 may not be available in a pre-mixed form. Third, the high fluorine content material 11 cannot be purchased or stored in a prepared form and needs to be prepared just prior to the applying at the stage 74. Accordingly, at a stage 72, the high fluorine content material 11 is prepared prior to being applied A to the stamp master at the stage 74. The process for preparing the high fluorine content material 11 will depend on the material selected. For commercially available fluoropolymer materials, a manufacturers specification sheet can provide guidance as to how the fluoropolymer material should be prepared.

The process of preparing the high fluorine content material 11 can include but is not limited to dissolving the high fluorine content material 11 in a solvent, adding the high fluorine content material 11 to a photo initiator to form a photocurable high fluorine content material, and adding a base material or a resin material to curing agent material and then mixing the materials with each other. The base/resin material can be added to the curing agent in a predetermined ratio by weight or the base/resin material can be added to the curing agent in a predetermined ratio by volume. A device such as a mixer or blender can be used to mix the materials with each other. The manufactures specification sheet can be consulted to determine a range of correct ratios for a given high fluorine content material 11. After the preparing at the stage 72, the high fluorine content material 11 can be applied A to the stamp master 50.

An exemplary high fluorine content material 11 includes a DUPONT® Teflon® AF amorphous fluoropolymer because the Teflon® AF family of amorphous fluoropolymers are optically transparent to light (including ultraviolet light), have excellent chemical resistance, low thermal conductivity, high molding temperatures, high gas permeability, and have desirable mechanical properties including mechanical strength, a low coefficient of friction, and a high creep resistance. Optical transparency is desirable because it allows a photocurable media to be cured by light that irradiates the media through the high fluorine content material 11 of the imprint stamp 10. Chemical resistance is desirable because a chemical reaction between the high fluorine content material 11 of the imprint stamp 10 and the media being embossed by the imprint stamp 10 can result in damage, wear, or loss of pattern fidelity in the imprint pattern 12. Finally, the properties of high creep resistance and mechanical strength are desirable so that the imprint stamp 10 has a long manufacturing lifetime and a mass production embossing process incorporating the imprint stamp 10 is economically viable because a cost of manufacturing the imprint stamp 10 can be recovered after several hundred or more embossing steps with the imprint stamp 10.

Teflon® AF is supplied as a solid (e.g. a powder) that is optically clear. Teflon® AF can be prepared by mixing the Teflon® AF with selected solvents. Examples of suitable solvents include but are not limited to a halogenated solvent, a perfluorinated solvent, and a fluorinated solvent. For example, a 3M® Fluorinert® Electronic Liquid, such as a FC-40, FC-70, or FC-77 can be used as the solvent. The resulting solution can be cast into a thin film coating that is free of defects such as pinholes and the like. The Teflon® AF solution can be applied A to the stamp master 50 and then cured C by removing the solvent by heating or drying the solution to drive off the solvent. For Teflon® AF, the heating to drive off residual solvent can be done at a low temperature so that the imprint stamp 10 or the optional substrate 21 connected with the imprint stamp 10 are not damaged by the heating. Another advantage to using Teflon® AF for the high fluorine content material 11 is that the thickness t_{S} of the imprint stamp 10 can be less than 1.0 μm. However, it may be desirable to have the thickness t_{S} be in the millimeter range as described above in order to facilitate easy removal of the imprint stamp 10 from the stamp master 50 and to facilitate easy handling the imprint stamp 10 after the removing. If the imprint stamp 10 is to thin, it could be damaged by handling (e.g. it could be torn by rough handling).

Other suitable fluoropolymers for the high fluorine content material 11 include but are not limited to PTFE and PFA. As one example, a Teflon® PTFE or a Teflon® PFA material can be used for the high fluorine content material 11. If optical transparency is important, then the amorphous fluoropolymers (e.g. Teflon® AF) have the lowest index of refraction and the highest optical clarity (>95%) when compared to the fluoropolymers PTFE and PFA. The amorphous fluoropolymers are also soluble in selected solvents as described above. Furthermore, perfluoropolyethers (PFPE's) also have desirable polymer properties including mechanical strength, a low coefficient of friction, excellent chemical resistance, and optical transparency. A liquid PFPE can be mixed with a photo initiator, be applied A in solution form to the stamp master 50, and then cured C using ultraviolet light (see FIG. 6b), for example.

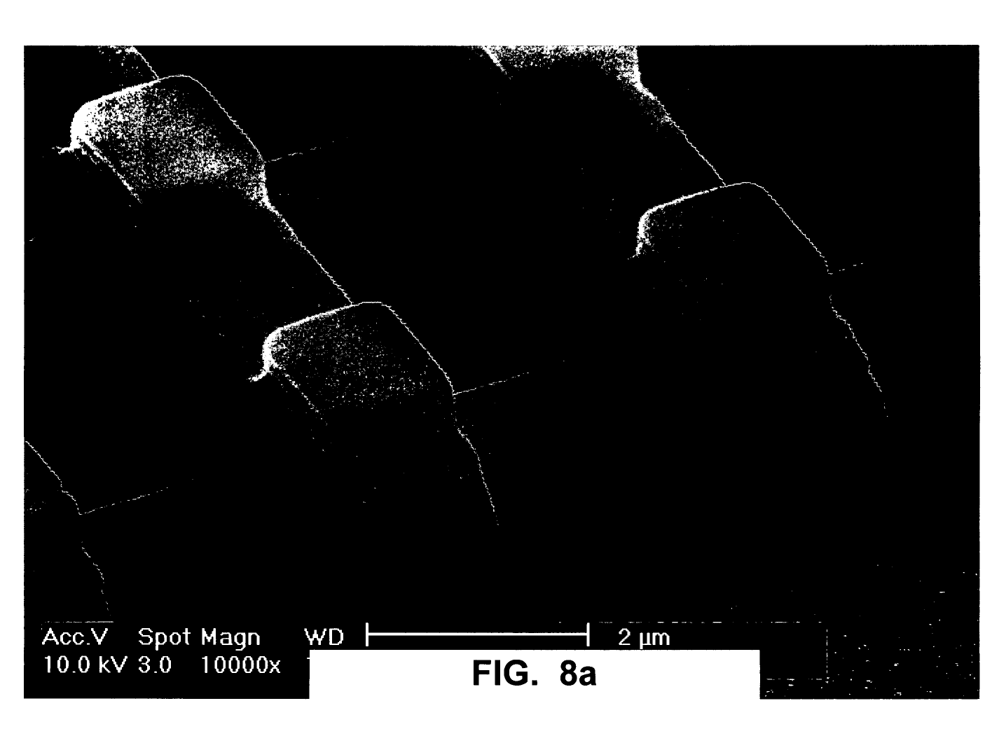

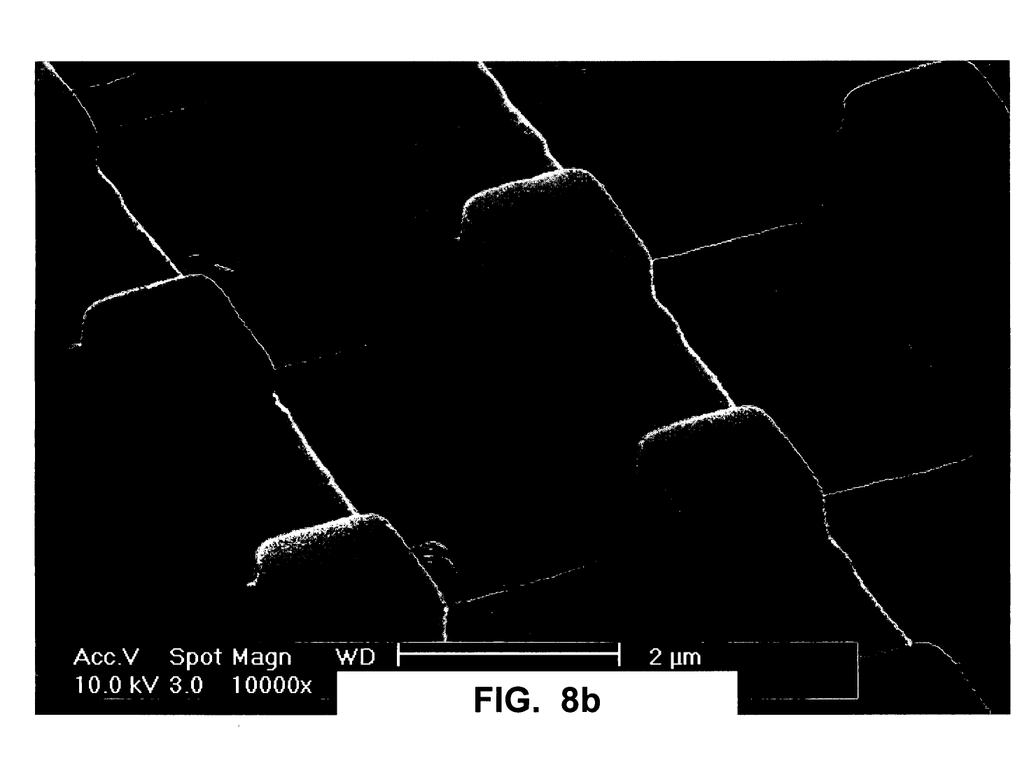

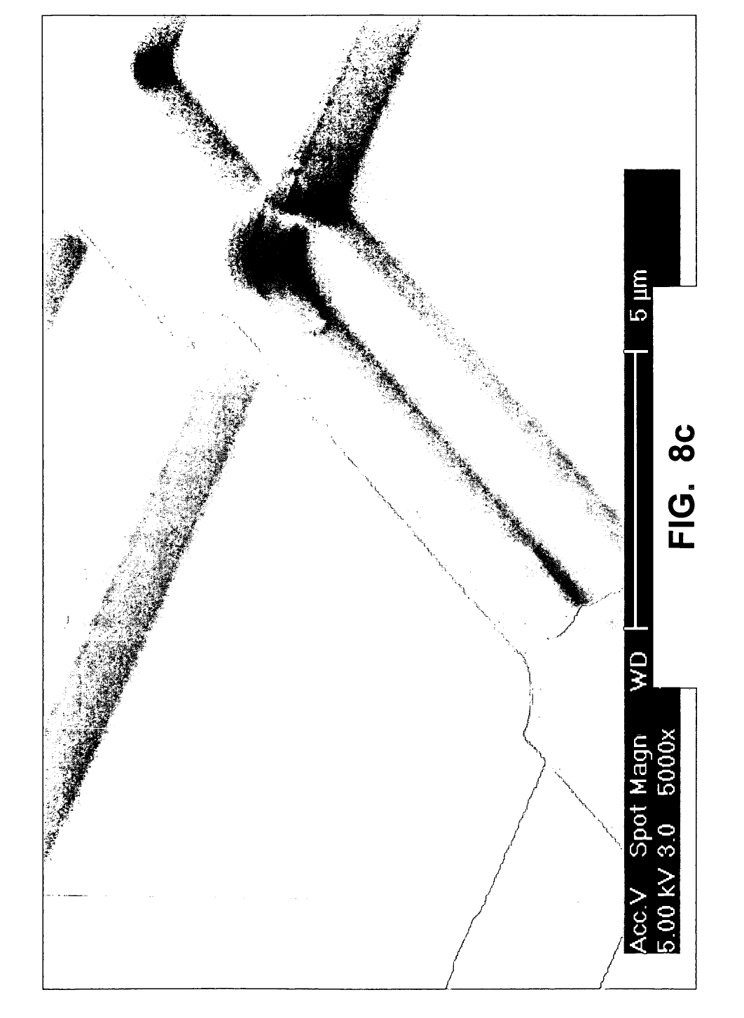

Turning to FIG. 8a, a Norland® NOA 83H photopolymer was embossed with the imprint stamp 10 when the imprint stamp 10 was new (i.e. the first pressing by the imprint stamp 10). The high fluorine content material 11 for the imprint stamp 10 was Teflon® AF. In FIG. 8b, a Norland® NOA 83H photopolymer was embossed by the same imprint stamp 10 used for the embossing in FIG. 8a, after about 500 pressings by the imprint stamp 10. Even after 500 pressings by the imprint stamp 10, the photopolymer material in FIG. 8b shows no significant defects or degradation in the pattern imprinted by the stamp 10 when compared to the imprinted pattern of FIG. 8a. Therefore, the high fluorine content material 11 of the imprint stamp 10 is durable, retains the fidelity of the imprint pattern 12, and is highly resistant to entraining contaminants present in the embossing environment. In FIG. 8c, a pattern imprinted in a photopolymer material by the imprint stamp 10 is one example of complex and high resolution submicron sized features that can be formed in the imprint pattern 12 and accurately replicated in a material embossed by the imprint stamp 10.

Although several embodiments of an apparatus and a method of the present invention have been disclosed and illustrated herein, the invention is not limited to the specific forms or arrangements of parts so described and illustrated. The invention is only limited by the claims.

What is claimed is:

1. An imprint stamp, comprising:
an imprint pattern connected with the imprint stamp, and
the imprint pattern and the imprint stamp are made from a high fluorine content material selected from the group consisting of a fluoropolymer, an amorphous fluoropolymer, and a perfluoropolyether.

2. The imprint stamp as set forth in claim 1, wherein the high fluorine content material is flexible.

3. The imprint stamp as set forth in claim 1, wherein the amorphous fluoropolymer comprises a TEFLON AF.

4. The imprint stamp as set forth in claim 1, wherein the high fluorine content material comprises a photocurable material.

5. The imprint stamp as set forth in claim 1, wherein the high fluorine content material is optically transparent to light.

6. The imprint stamp as set forth in claim 5, wherein the high fluorine content material is optically transparent to ultraviolet light.

7. The imprint stamp as set forth in claim 1 and further comprising a substrate connected with the imprint stamp.

8. The imprint stamp as set forth in claim 7, wherein the substrate includes a shape selected from the group consisting of a substantially planar shape, an arcuate shape, and a cylindrical shape.

9. The imprint stamp as set forth in claim 7, wherein a selected one of the substrate, the high fluorine content material, or the substrate and the high fluorine content material are optically transparent to light.

10. The imprint stamp as set forth in claim 9, wherein the light is ultraviolet light.

11. The imprint stamp as set forth in claim 1, wherein the imprint pattern includes a minimum feature size.

12. The imprint stamp as set forth in claim 11, wherein the minimum feature size is less than 100 nanometers.

13. A method of fabricating an imprint stamp, comprising:
applying a high fluorine content material to a stamp master that includes a pattern to be replicated in the imprint stamp as an imprint pattern,
the high fluorine content material comprises a material selected from the group consisting of a fluoropolymer, an amorphous fluoropolymer, and a perfluoropolyether;
curing the high fluorine content material so that the imprint pattern is fixed in the imprint stamp; and
removing the imprint stamp from the stamp master.

14. The method as set forth in claim 13, wherein the amorphous fluoropolymer comprises a TEFLON AF.

15. The method as set forth in claim 13, wherein the high fluorine content material comprises a photocurable material.

16. The method as set forth in claim 13, wherein the curing comprises a selected one of heating or drying the high fluorine content material for a predetermined time.

17. The method as set forth in claim 13, wherein the curing comprises irradiating the high fluorine content material with light.

18. The method as set forth in claim 17, wherein the light comprises ultraviolet light.

19. The method as set forth in claim 13 and further comprising:
connecting the imprint stamp with a substrate.

20. The method as set forth in claim 13 and further comprising prior to the applying:
preparing the high fluorine content material.

21. The method as set forth in claim 20, wherein the preparing the high fluorine content material comprises dissolving the high fluorine content material in a solvent.

22. The method as set forth in claim 20, wherein the preparing the high fluorine content material comprises adding the high fluorine content material to a photo initiator to form a photocurable high fluorine content material.

23. The method as set forth in claim 20, wherein the preparing the high fluorine content material comprises adding a selected one of a base material or a resin material to a curing agent material in a predetermined ratio by weight or in a predetermined ratio by volume, and mixing the materials with each other.

24. The method as set forth in claim 13, wherein the applying comprises a process selected from the group consisting of coating, pouring, spraying, spin coating, depositing, brushing, dipping, and spreading.

25. The method as set forth in claim 13, wherein the removing comprises a process selected from the group consisting of
peeling the imprint stamp off of the stamp master,
applying an adhesive material to the imprint stamp and then peeling the imprint stamp off of the stamp master,
applying an adhesive material to the imprint stamp and then lifting the imprint stamp off of the stamp master, and
applying an adhesive material to the imprint stamp and then rolling the imprint stamp off of the stamp master.

26. The method as set forth in claim 13 and further comprising:
coating the stamp master with a release material prior to the applying the high fluorine content material.

27. An imprint stamp fabricated according to the method as set forth in claim 13.

28. The imprint stamp as set forth in claim 27, wherein the amorphous fluoropolymer comprises a TEFLON AF.
